(19) United States
(12) Patent Application Publication
(10) Pub. No.: US 2002/0184721 A1
(43) Pub. Date: Dec. 12, 2002

(54) Front vehicle attachment for power brooms and the like

(76) Inventor: Ken Jackson, Saskatoon (CA)

Correspondence Address: STITES & HARBISON, PLLC, 400 W MARKET ST, SUITE 1800, LOUISVILLE, KY, 40202-3352, US

(21) Appl. No.: 09/877,771

(22) Filed: Jun. 8, 2001

(51) Int. Cl. E01H 1/05; B60R 27/00

(52) U.S. Cl. 15/82; 280/760

(57) ABSTRACT

An attachment apparatus for attaching a ground following implement, such as a power rotary broom, to a front portion of a vehicle comprises a frame pivotally attachable to the vehicle about a first pitch axis such that a front end of the frame is positioned in front of the vehicle. The front end of the frame is pivotally attachable to an implement about a second pitch axis. Castor wheels are arranged to support the frame for movement along the ground. A front mounted broom is driven at a mid-point so that no drive parts protrude from either end thereof.

This invention is in the field of grounds keeping and like implements and in particular such implements attached to the front of a vehicle.

### BACKGROUND

It is well known to attach various implements such as power brooms, blades and the like to the front of various implements such as tractors, skid-steer loaders and the like. Recently all-terrain vehicles and utility vehicles have become available and demand is developing for implements that can be attached to these vehicles.

All-terrain vehicles are essentially designed to carry passengers on a seat provided. They often have four wheel drive and generally have high ground clearance for traveling over rough terrain. Similarly utility vehicles are designed to carry passengers, and also have a box for carrying cargo, similar to a small truck, and often have lower ground clearance than all-terrain vehicles. Utility vehicles are commonly used for golf course maintenance and the like.

These vehicles handle the jobs they were designed for well, however users would like to expand their range of utility. instead of owning an all-terrain or utility vehicle as well as a tractor, the user would prefer to have the all-terrain or utility vehicle perform the duties of the tractor, thereby reducing the need for the tractor, or eliminating it altogether.

While a tow hitch is commonly provided at the rear of these all-terrain and utility vehicles they are not designed for carrying added weight on the front end. Conventional front attachment of implements requires the front end of the vehicle to carry the weight of the implement, at least during transport, resulting in excessive weight on the front end of all-terrain or utility vehicles.

Similarly, other multi-purpose vehicles have also been developed for attachment of implements, however the weight inherent in front mounted implements often causes stability and stress problems. Tractors and like conventional vehicles where such implements are commonly front mounted can also experience stability problems with heavy implements such as rotary brooms.

U.S. Pat. No. 6,006,390 to Bischel et al. discloses an apparatus for mounting a power rotary broom to a vehicle while allowing for the typically desired movement of the broom head about the desired roll, yaw, and pitch axes. The roll axis extends parallel to the travel direction and to the ground and allows the broom head to follow side-to-side contours of the ground. The yaw axis is substantially vertical and allows the broom head to be angled to sweep to the right, left, or straight ahead.

A single pitch axis is provided, substantially perpendicular to the travel direction of the vehicle and parallel to the ground. The implement floats up and down on this pitch axis to follow ground contours, and also pivots up and down on this same pitch axis to move into a raised transport position. The disclosure discusses the stability problem encountered when the broom is raised to the transport position, and all weight is on the front of the vehicle.

U.S. Pat. Nos. 4,214,338 to Kyle, 4,811,442 to Barker, 4,910,948 to Nelson, 5,187,828 to Hoffman et al., 5,279,014 to Wise et al., and 6,088,865 to Truan et al. also disclose front mounting apparatuses for implements such as brooms and dethatchers. These attachment apparatuses require that the weight of the implement be carried by the front end of the vehicle when the implement is raised to a transport position.

Power rotary brooms conventionally are driven by a chain and sprocket or hydraulic motor mounted on one end of the broom These conventional drives interfere with operations close to walls and other upright obstructions as the drive protrudes from the driven end.

### SUMMARY OF THE INVENTION

It is the object of the present invention to provide an apparatus for attaching an implement to the front of a vehicle such that the weight of the implement is not carried by the vehicle.

It is a further object of the present invention to provide such an apparatus that allows the implement to roll, pitch and yaw to follow ground contours and otherwise properly position the implement.

It is a further object of the present invention to provide an apparatus for sweeping a surface that allows utilization of a wider range of vehicles to power the sweeper.

It is a further object of the present invention to provide an apparatus for sweeping a surface that has no drive parts protruding beyond either end of the broom head.

In a first aspect the invention provides an attachment apparatus for attaching a ground following implement to a front portion of a vehicle. The apparatus comprises a frame having a vehicle end pivotally attachable to the vehicle about a first pitch axis such that an implement end of the frame is positioned in front of the vehicle, the implement end pivotally attachable to an implement about a second pitch axis; and at least one wheel arranged to support the frame for movement thereof along the ground.

The apparatus of the invention allows the implement, such as a broom or blade, to follow ground contours by pivoting about two pitch axes. The frame is supported on the ground by wheels and pivots about the first pitch axis with respect to the vehicle to follow the ground. The wheels could be arranged as castor wheels, or other arrangement that allows the frame to turn with the vehicle. The implement pivots follow the ground, and also to move into a raised transport position.

When in the transport position, the weight of the implement is carried by the front end of the frame which is supported by the wheels rather than by the vehicle. The vehicle supports only the vehicle end of the frame, and may in fact experience an upward force when the implement is moved to the transport position, depending on the placement of the wheels along the frame. In most cases the wheels will be positioned near the front implement end of the frame to reduce this upward force.

In a second aspect the invention provides an apparatus for sweeping a surface comprising a vehicle and a frame having a vehicle end pivotally attached to the vehicle about a first pitch axis and a broom end positioned in front of the vehicle. A rotary broom is pivotally attached to the broom end of the frame about a second pitch axis and at least one castor wheel is arranged to support the frame as the vehicle moves along the ground. A drive is operative to rotate the broom head.

The apparatus is particularly suited to rotary power brooms which are quite heavy, and have been problematic for mounting on all-terrain or utility vehicles, which are not designed to carry added weight on the front end. Roll and yaw pivots required by such brooms are readily incorporated into the frame.

In a third aspect the invention provides an apparatus for sweeping a surface comprising a frame supported on wheels for movement along the surface. A rotary broom head comprises a broom head shaft and the broom head shaft is rotatably attached to the frame. A drive is connected to a mid-point of the broom head shaft by a flexible drive element and is operative to rotate the broom head. The midpoint is located such that bristles of the broom head rotate on each side of the drive element.

The drive eliminates any projecting drive mechanisms on a side of the broom which interfere with operations close to walls and like upright obstructions. Broom bristles are generally mounted on the broom head shaft in spaced circumferential arrays, with the bristles spread to sweep the area between adjacent arrays. With a drive of the invention, it may be required to slightly increase the space between the arrays on each side of the drive element however this has not been found to seriously reduce the effectiveness of the broom when sweeping.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the invention where the frame is mounted under the vehicle at a mid-point thereof;

FIG. 2 is a schematic side view of an alternate embodiment of the invention where the frame is mounted at the front end of the vehicle;

FIG. 3 is a schematic top view of a vehicle and implement showing the yaw axis;

FIG. 4 is a schematic front view of a vehicle and implement showing the roll axis;

FIG. 5 is a side view of an apparatus of the invention where the implement is a broom in the operating position;

FIG. 6 is a side view of the broom of FIG. 5 where the broom is raised to the transport position;

FIG. 7 is an exploded perspective view of the attachment apparatus of FIGS. 5 and 6;

FIG. 8 is an exploded perspective view of the broom of FIGS. 5 and 6.

### DETAILED DESCRIPTION OF THE ILLUSTRATED EMBODIMENTS

FIG. 1 schematically illustrates an attachment apparatus 1 for attaching a ground following implement, illustrated as a power rotary broom 2, to a front portion of a vehicle 3. The apparatus 1 comprises a frame 4 having a vehicle end 4B pivotally attachable to the vehicle about a first pitch axis PA1 such that an implement end 4A of the frame 4 is positioned in front of the vehicle 3. The implement end 4A is pivotally attachable to a broom 2 about a second pitch axis PA2. At least one wheel 5 is arranged to support the frame 4 for movement thereof along the ground 7. The illustrated wheel 5 is a castor wheel to allow for the apparatus 1 to be steered with the vehicle 3. A drive motor 9 rotates the broom head 10.

In FIG. 1 the first pitch axis PA1 is located near the middle of the underside of the vehicle 3. Such a mid mounting position is desired with many vehicles to maintain handling and reduce stress caused by the broom 2. A disadvantage to this mid mounting position is that the upward range of movement about the first pitch axis PA1 is reduced because the frame 4 quickly comes into contact with the vehicle 3 as it moves up. This reduced upward range limits travel over vertical obstructions such as curbs, and hinders movement up loading ramps and the like.

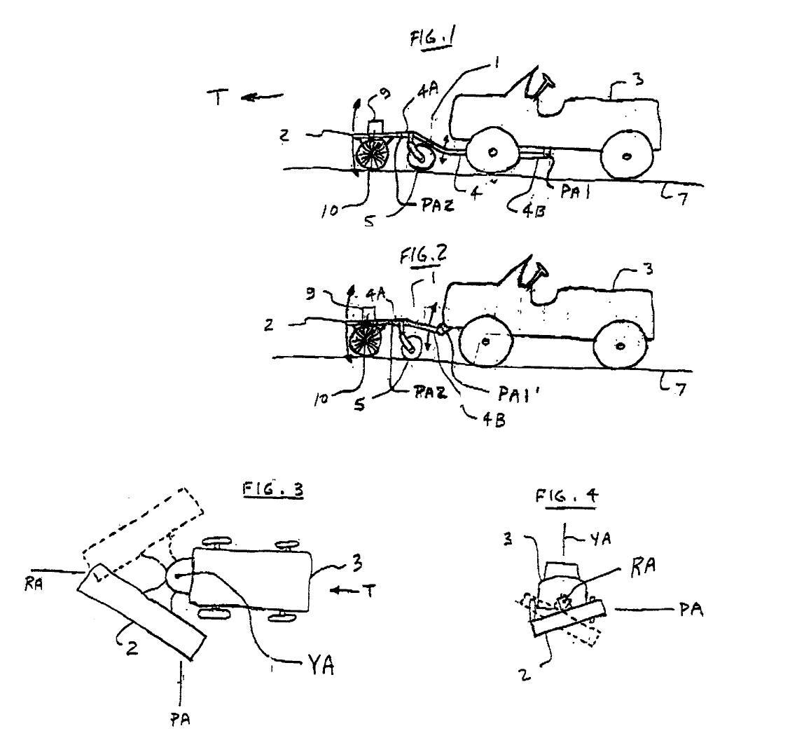

FIG. 2 schematically illustrates an alternate location for the first pitch axis PA1 in proximity to the front end of the vehicle 3 such that the frame 4 can move much higher without contacting the vehicle 3. Such a location allows the vehicle with the attached implement to more easily climb curbs, ramps, and the like. Again in this embodiment the vehicle does not carry the weight of the implement.

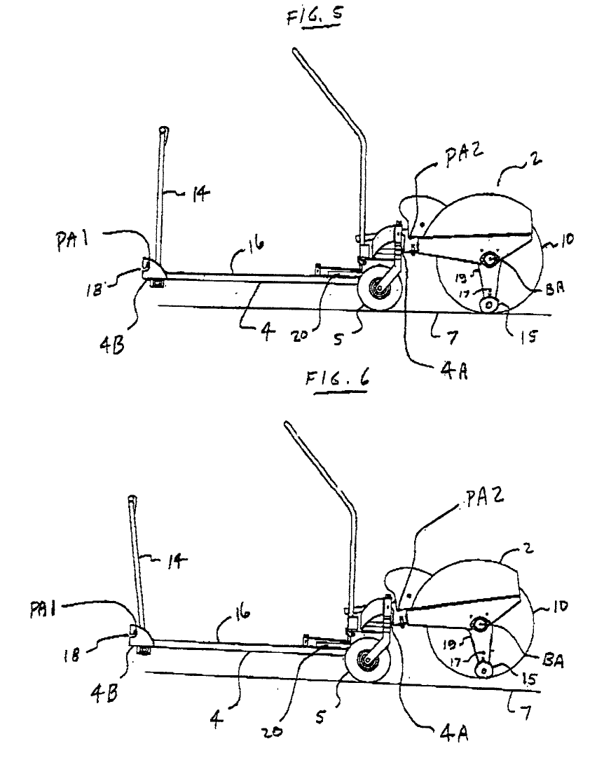

Typically it is desired to attach the broom 2, or other implement to the vehicle 3 so that it may pivot about pitch, yaw and roll axes. The pitch axis PA, illustrated as PA1, PA2 in FIGS. 1 and 2, is shown in FIGS. 3 and 4 to further illustrate the generally horizontal orientation of the pitch axis substantially perpendicular to the travel direction T of the vehicle 3.

FIGS. 3 and 4 illustrate the vertical orientation of the yaw axis YA which allows the broom 2 to pivot towards each side, for example to sweep or push material to one side or the other. FIGS. 3 and 4 also illustrate the horizontal orientation of the roll axis RA parallel to the travel direction T of the vehicle 3. The yaw and roll axes YA, RA are illustrated substantially in the center of the vehicle 3 as will be usual in most situations.

FIG. 5 illustrates the broom 2 in the lowered operating position with the broom head 10 in contact with the ground 7. A transport control 14 is operable to selectively pivot the broom 2 about the second pitch axis PA2 into a raised transport position as illustrated in FIG. 6 where the broom head 10 is above the ground 7, and into then back into the lowered operating position of FIG. 5.

Where required for accurate vertical control, a float wheel 19 can be mounted at each end of the broom 2, substantially vertically under a rotational axis BA of the broom 2. The vertical position of the float wheels 15 with respect to the broom 2 is adjustable by mounting same in selected wheel holes 17 in brackets 19. With the float wheels in this position, directly under the rotational axis BA of the broom 2 at the point where the boom head 10 contacts the ground 7, maximum control of the height of the broom 2 with respect to the ground 7 is achieved as the float wheels follow the same ground contours as the broom head 10. Conventionally such float wheels are located somewhat behind, or occasionally ahead of, the rotational axis BA, thus providing reduced height control because they are removed from the point of contact between the broom and ground surface. Precision height control is desired for some jobs such as de-thatching lawns. Good height control also reduces bristle wear.

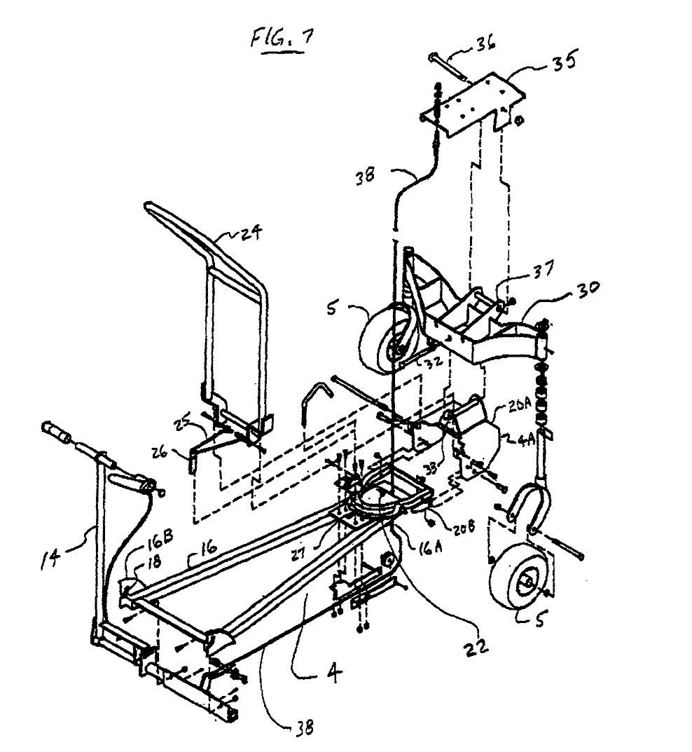

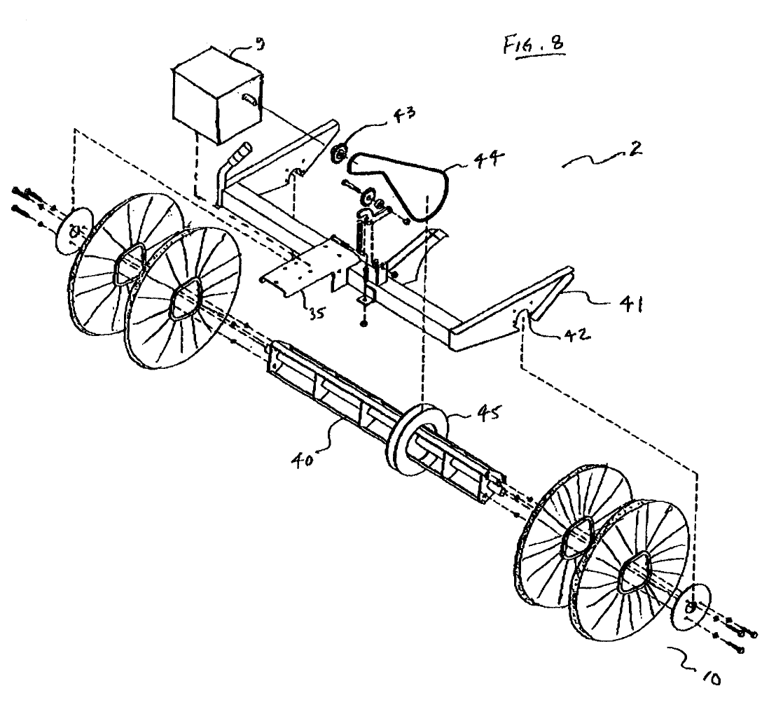

The attachment apparatus of FIGS. 5 and 6 is illustrated in some detail in FIG. 7. In order to provide a yaw pivot such that the broom 2 can yaw with respect to the vehicle 3 about a yaw axis YA the frame comprises a main frame 16 having a rear end 16B pivotally attached to the vehicle 3 about the first pitch axis PA1. Slots 18 on the main frame 16 engage pins on the vehicle 3 to provide the first pivot axis PA1. A yaw frame 20 comprises front and rear yaw frame members 20A, 20B fixedly attached together by bolts. The rear yaw frame member 20B is pivotally attached to the front end 16A of the main frame 16 about the yaw axis YA at yaw pin 22.

Yaw control 24 acts through cables 25 to move key 26 into and out of engagement with notches 27 in the rear yaw frame member 20B. The operator is thus able to yaw the broom 2 as desired.

The apparatus 1 also comprises a roll pivot operatively connected to the frame 4 such that the broom 2 can roll with respect to the vehicle 3 about a roll axis RA. The frame 4 further comprises a roll frame 30 at the implement end 4A thereof pivotally attached to the broom 2 about the second pitch axis PA2 and pivotally attached to the frame 4 about the roll axis RA. The roll frame 30 is pivotally attached to an upper portion of the front yaw frame member 20A by roll pin 32 through roll hole 33. Roll pin 32 thus provides the roll axis RA.

The motor mount 35 is pivotally attached to the roll frame 30 by pitch pin 36 through pitch hole 37. The pitch pin 36 thus provides the second pitch axis PA2. The broom 10 is fixed to the motor mount 35 as illustrated in FIG. 8. Transport control 14 pulls on transport cable 38 to move the rear end of the motor mount 35 down causing the motor mount to pivot about the second pitch axis PA2 and thus causing the broom 2 fixed to the opposite front end of the motor mount 35 to move up into the transport position. Intermediate fixed vertical positions could also be provided to maintain the broom head 10 in a fixed vertical position relative to the vehicle 3, rather than floating as illustrated.

The yaw and transport controls could alternately incorporate electric or hydraulic actuators for remote and powered operation.

A pair of castor wheels 5 are attached to the roll frame 30 to support the frame 4 as the vehicle 3 moves along the ground 7.

FIG. 8 illustrates the broom 2. The broom drive comprises a motor 9, such as an internal combustion or hydraulic motor, mounted on the motor mount 35 fixed to the broom 2. The broom 2 comprises a broom head 10 including a broom head shaft 40 rotatably mounted to a broom head housing 41 at bearing mounts 42. A shroud 47 is not shown in FIG. 8, but can be seen in FIGS. 5 and 6.

The flexible drive element is illustrated as a chain 44 connecting a drive sprocket 43 on the motor 9 to a driven sprocket 45 at a midpoint of the broom head shaft 40. Bristles 46 of the broom head 10 rotate on each side of the chain 44 and driven sprocket 45. With this arrangement, no drive parts extend from either end of the broom head 10, unlike conventional broom drives. Either end of the broom 2 then can sweep equally close to vertical obstructions, such as walls, posts and the like. In suitable applications, a belt and drive pulley could be substituted for the chain 44 and drive sprocket 43.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. An attachment apparatus for attaching a ground following implement to a front portion of a vehicle, the apparatus comprising:
a frame having a vehicle end pivotally attachable to the vehicle about a first pitch axis such that an implement end of the frame is positioned in front of the vehicle, the implement end pivotally attachable to an implement about a second pitch axis; and
at least one wheel arranged to support the frame for movement thereof along the ground.

2. The apparatus of claim 1 wherein the implement is movable to a transport position by pivoting about the second pitch axis.

3. The apparatus of claim 1 further comprising a yaw pivot operatively connected to the frame such that the implement can yaw with respect to the vehicle about a yaw axis.

4. The apparatus of claim 1 further comprising a roll pivot operatively connected to the frame such that the implement can roll with respect to the vehicle about a roll axis.

5. The apparatus of claim 3 further comprising a roll pivot operatively connected to the frame such that the implement can roll with respect to the vehicle about a roll axis.

6. The apparatus of claim 1 comprising two castor wheels supporting the frame for movement along the ground.

7. An apparatus for sweeping a surface comprising:
a vehicle;
a frame having a vehicle end pivotally attached to the vehicle about a first pitch axis and a broom end positioned in front of the vehicle;
a rotary broom pivotally attached to the broom end of the frame about a second pitch axis;
at least one castor wheel arranged to support the frame as the vehicle moves along the ground; and
a drive operative to rotate the broom head.

8. The apparatus of claim 7 further comprising a transport control operable to selectively pivot the broom about the second pitch axis into a raised transport position and into a lowered operating position.

9. The apparatus of claim 7 wherein the frame provides a yaw pivot such that the broom can yaw with respect to the vehicle about a yaw axis.

10. The apparatus of claim 9 wherein the frame comprises:
a main frame having a rear end pivotally attached to the vehicle about the first pitch axis, and having a front end; and
a yaw frame having a rear end pivotally attached to the front end of the main frame about a yaw axis, and having a front end pivotally attached to the broom about the second pitch axis

11. The apparatus of claim 10 further comprising a roll pivot operatively connected to the frame such that the broom can roll with respect to the vehicle about a roll axis.

12. The apparatus of claim 11 wherein the frame further comprises a roll frame at the broom end thereof pivotally attached to the broom about the second pitch axis, and pivotally attached to the frame about a roll axis.

13. The apparatus of claim 12 comprising a pair of castor wheels attached to the roll frame to support the frame as the vehicle moves along the ground.

14. The apparatus of claim 7 wherein the drive comprises a motor mounted on the broom.

15. The apparatus of claim 14 wherein the broom comprises a broom head shaft rotatably mounted to a broom head housing, and wherein the motor drives the broom by a flexible drive element connecting the motor and a midpoint of the broom head shaft, the mid-point located such that bristles of the broom head rotate on each side of the drive element.

16. The apparatus of claim 7 further comprising a float wheel mounted at each end of the broom, substantially vertically under a rotational axis of the broom.

17. The apparatus of claim 16 wherein a vertical position of the float wheels with respect to the broom is adjustable.

18. The apparatus of claim 7 wherein the first pitch axis is located in proximity to a front end of the vehicle.

19. The apparatus of claim 7 wherein the first pitch axis is located at a mid-point of an underside of the vehicle.

20. An apparatus for sweeping a surface comprising:
a frame supported on wheels for movement along the surface;
a rotary broom head comprising a broom head shaft, the broom head shaft rotatably attached to the frame;
a drive connected to a mid-point of the broom head shaft by a flexible drive element and operative to rotate the broom head, the mid-point located such that bristles of the broom head rotate on each side of the drive element.

21. The apparatus of claim 20 wherein the drive comprises a motor mounted on the broom.

22. The apparatus of claim 20 further comprising a shield attached to the frame and operative to reduce contact between the drive element and the bristles.

23. The apparatus of claim 20 wherein the drive element is a chain and further comprising a drive sprocket attached at a mid-point of the broom head shaft.

24. The apparatus of claim 20 wherein the drive element is a belt and further comprising a drive pulley attached at a mid-point of the broom head shaft.
